(19) United States
(12) Patent Application Publication
(10) Pub. No.: US 2011/0170586 A1
(43) Pub. Date: Jul. 14, 2011

(54) APPARATUS AND METHOD FOR PREDICTING SINR IN SPATIALLY MULTIPLEXED MULTIPLE INPUT MULTIPLE OUTPUT SYSTEM

(75) Inventor: Seungjae BAHNG, Daejeon (KR)

(73) Assignee: Electronics and Telecommunications Research Institute, Daejeon (KR)

(21) Appl. No.: 12/908,437

(22) Filed: Oct. 20, 2010

(30) Foreign Application Priority Data
Jan. 13, 2010 (KR) 10-2010-0003205

(51) Int. Cl. H04B 17/00

(52) U.S. Cl. 375/227

(57) ABSTRACT

A receiver of a spatially multiplexed multiple input multiple output (SM MIMO) system divides the SM MIMO system into a plurality of virtual single input multiple output (SIMO) systems by using the estimated channel, calculates losses generated by the plurality of streams received through the plurality of reception antennas, and predicts an SINR of each stream by using the losses and the capacities of the plurality of virtual SIMO systems. It is possible to more accurately estimate the performance of a maximum likelihood (ML) detector or the performance of a detector showing the performance of a maximum likelihood (ML) detection mechanism by using the estimated SINR of each stream.

### CROSS-REFERENCE TO RELATED APPLICATION

This application claims priority to and the benefit of Korean Patent Application No. 10-2010-0003205 filed in the Korean Intellectual Property Office on Jan. 13, 2010, the entire contents of which are incorporated herein by reference.

### BACKGROUND OF THE INVENTION

(a) Field of the Invention

The present invention relates to an apparatus and a method for predicting the signal to interference plus noise ratio (SINR) in a spatially multiplexed multiple input multiple output (SM MIMO) system.

(b) Description of the Related Art

The transmission mechanism of a spatially multiplexed multiple input multiple output (SM MIMO) antenna system is regarded as one of methods capable of supporting multimedia service requiring high-speed transmission of data and satisfying transmission speed required in a wireless communication system.

In the SM MIMO system, transmission antennas of a transmitter increases data quantity by transmitting different data without allocating additional transmission power or frequency, while a receiver needs a lot of efforts to detect spatially multiplexed data.

The detection mechanism in the receiver includes a linear detection mechanism, a maximum likelihood (ML) detection mechanism, and an ordered successive interference cancellation (OSIC) mechanism which is a non-linear detection mechanism and among them, the ML detection mechanism is known to an optimum detection mechanism.

The ML detection mechanism is a mechanism of finding a transmission signal vector having the smallest ML metric by calculating an ML metric for each of transmission signal vectors of a valid combination in order to detect an optimal transmission signal vector. Since calculation complexity is exponentially increased by the number of transmission antennas and the size of a constellation, the ML detection mechanism is very difficult to implement hardware.

On the contrary, the linear detection mechanism minimizes an influence of an interference signal by using zero forcing (ZF) and a minimum mean square error (MMSE) mechanism by detecting only a predetermined signal and considering other signals as the interference signal in each reception antenna and has low complexity, but performance is markedly deteriorated by noise amplification.

Further, the OSIC mechanism well known as V-BLAST has higher calculation complexity than the linear detection, but the OSIC mechanism has improved performance in comparison with the linear detection mechanism. However, compared with the performance of the ML detection mechanism, the OSIC mechanism has markedly deteriorated performance.

Meanwhile, an effective signal to interference plus noise ratio (SINR) is easily calculated when a linear receiver (i.e., MMSE detector) is used in a single input single output (SISO) system, a single input multiple output (SIMO) system, and a multiple input multiple output (MIMO) system and the performance of the linear receiver can be estimated through the effective SINR. Further, the calculated effective SINR is reported to a base station and is usable for various usages such as scheduling, link adaptation, etc.

Communication signal processing technologies, which have been recently developed, have low complexity and propose various methods to show the performance of the ML detection mechanism. As one example, a signal detection method disclosed in Korean Patent No. 0808633 is presented.

Accordingly, a method for easily predicting the performance of an ML detector using the ML detection mechanism or the performance of a detector showing the performance of the ML detection mechanism is required even in an SM MIMO system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for predicting a signal to interference plus noise ratio (SINR) in a spatially multiplexed multiple input multiple output system that can easily predict the performance of a detector showing the performance of an ML detection mechanism in the spatially multiplexed multiple input multiple output system.

An exemplary embodiment of the present invention provides a method for predicting a signal to interference plus noise ratio (SINR) in a receiver of a spatially multiplexed multiple input multiple output (SM MIMO) antenna system. The method for predicting a signal to interference plus noise ratio includes: estimating a channel by using a plurality of streams received through a plurality of reception antennas; dividing a capacity of the SM MIMO system into capacities of a plurality of virtual single input multiple output (SIMO) systems by using the estimated channel; calculating losses generated by the plurality of streams received through the plurality of reception antennas; and predicting an SINR of each stream by using the losses and the capacities of the plurality of virtual SIMO systems.

Another embodiment of the present invention provides an apparatus for predicting a signal to interference plus noise ratio (SINR) in a spatially multiplexed multiple input multiple output (SM MIMO) system. The apparatus for predicting a signal to interference plus noise ratio includes: a system capacity calculator, a loss calculator, a stream capacity approximator, and a predictor. The system capacity calculator divides the SM MIMO system into a plurality of virtual single input multiple output (SIMO) systems and calculates a capacity of the SM MIMO system and capacities of the plurality of virtual SIMO systems. The loss calculator calculates losses generated by a plurality of streams received through a plurality of reception antennas by using the capacity of the SM MIMO system and the capacities of the plurality of virtual SIMO systems. In addition, the stream capacity approximator approximates a capacity of each stream by using the losses and the capacities of the plurality of virtual SIMO systems. Further, the predictor predicts the SINR of each stream by using the capacity of each stream.

### BRIEF DESCRIPTION OF THE DRAWINGS

FIG. 1 is a diagram schematically showing an SM MIMO system according to the present invention;

FIG. 2 is a schematic diagram of an apparatus for predicting a signal to interference plus noise ratio in an SM MIMO system according to an exemplary embodiment of the present invention;

FIG. 3 is a flowchart showing a method for predicting a signal to interference plus noise in an SM MIMO system according to an exemplary embodiment of the present invention;

FIG. 4 is a diagram showing a 2×2 SM MIMO system;

FIGS. 5 and 6 are diagrams each showing a virtual SIMO system;

FIG. 7 is a diagram showing a mapping relationship between an SINR and symbol information in an OFDMA system;

FIG. 8 is a diagram showing the relationship between a PBIR and an effective SINR in an OFDMA system; and

FIG. 9 is a diagram showing a simulation result using an effective SINR.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification and the appended claims, in addition, unless explicitly described to the contrary, the word “comprise” and variations such as “comprises” or “comprising”, will be understood to imply the inclusion of stated elements but not the exclusion of any other elements.

Hereinafter, an apparatus and a method for predicting a signal to interference plus ratio in a spatially multiplexed multiple input multiple output (SM MIMO) system according to an exemplary embodiment of the present invention.

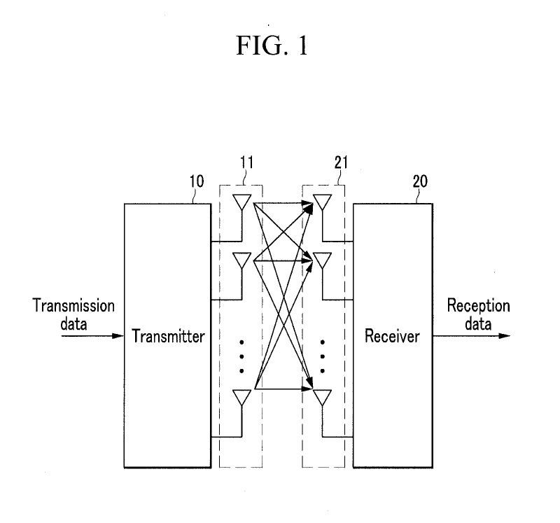

FIG. 1 is a diagram schematically showing an SM MIMO system according to the present invention.

Referring to FIG. 1, the SM MIMO system includes a transmitter 10 and a receiver 20. The transmitter 10 includes a plurality of transmission antennas 11. The receiver 20 includes a plurality of reception antennas 21.

The transmitter 10 signal-processes transmission data and thereafter, divides the corresponding transmission data into low-speed streams as many as the number of the transmission antennas 11, and simultaneously transmits them through the transmission antennas 11.

The receiver 20 determines the transmission data by using the streams received through the reception antennas 21 and signal-processes the determined transmission data to acquire a desired reception antenna.

The receiver 20 according to the exemplary embodiment of the present invention includes an ML detector (not shown) determining the transmission data by using a maximum likelihood (ML) detection mechanism or a detector (not shown) determining the transmission data by using a detection mechanism showing the performance of the ML detection mechanism. At this time, the receiver 20 of the SM MIMO system according to the exemplary embodiment of the present invention predicts a signal to interference plus noise ratio (SINR) with an estimated channel so as to predict the performance of the ML detector or the detector showing the performance of the ML detection mechanism.

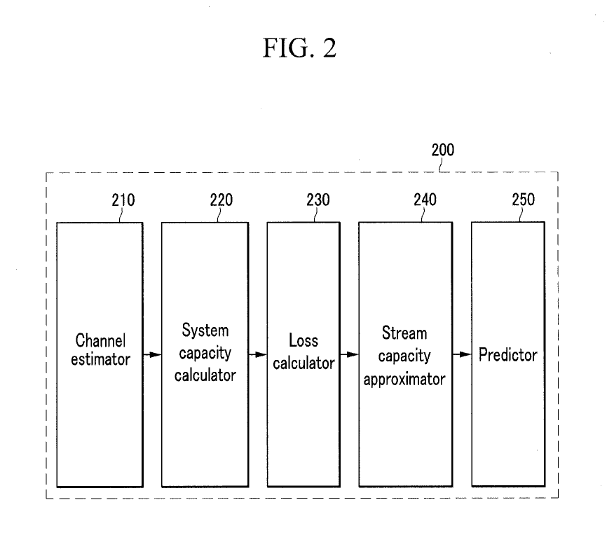

Next, a method for predicting the SINR in the SM MIMO system will be described with reference to FIGS. 2 to 6.

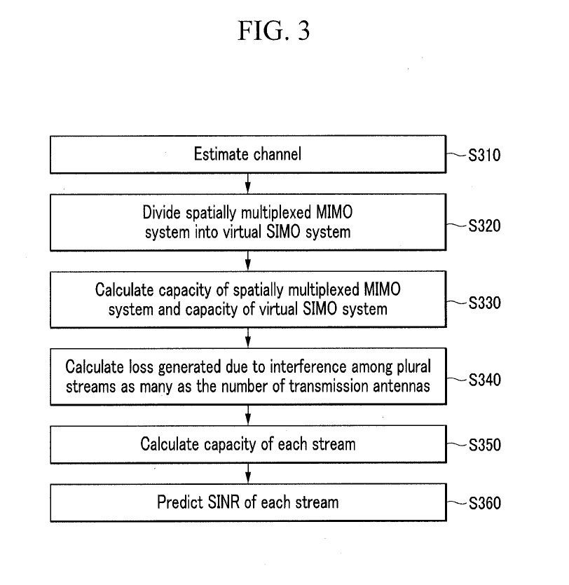

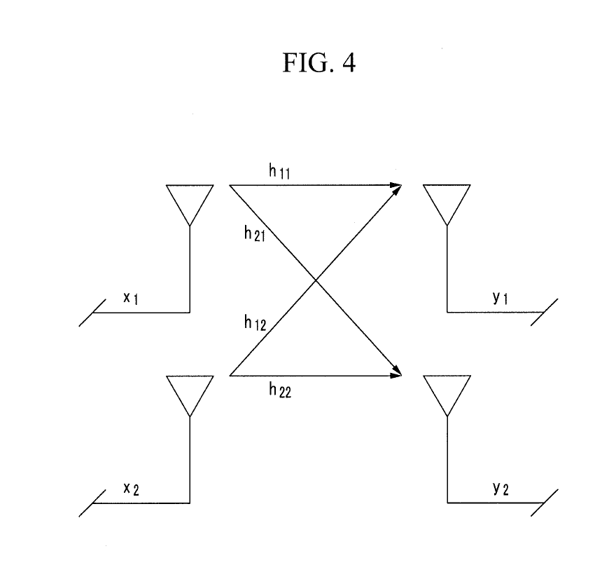

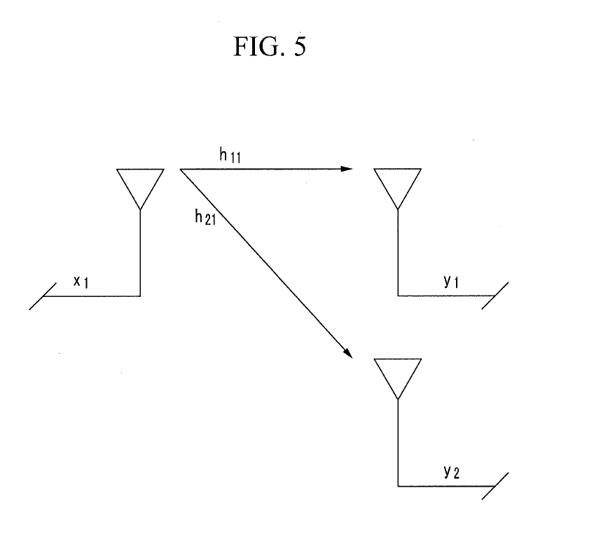

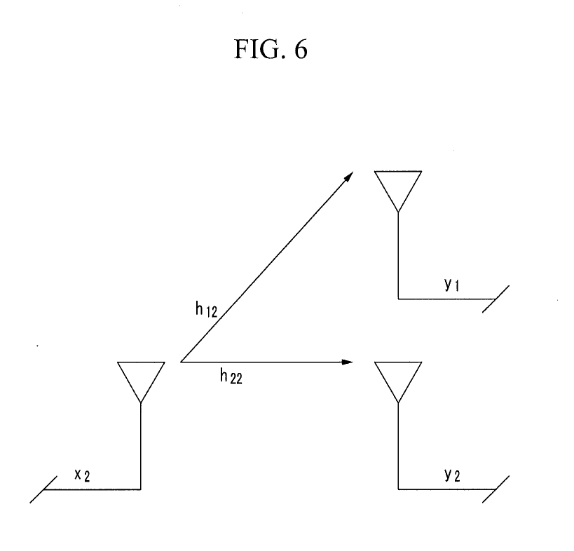

FIG. 2 is a schematic diagram of an apparatus for predicting a signal to interference plus noise ratio in an SM MIMO system according to an exemplary embodiment of the present invention and FIG. 3 is a flowchart showing a method for predicting a signal to interference plus noise in an SM MIMO system according to an exemplary embodiment of the present invention. FIG. 4 is a diagram showing a 2×2 SM MIMO system and FIGS. 5 and 6 are diagrams each showing a virtual SIMO system.

Referring to FIG. 2, the SINR predicting apparatus 200 includes a channel estimator 210, a system capacity calculator 220, a loss calculator 230, a stream capacity approximator 240, and a predictor 250.

The channel estimator 210 estimates a wireless channel H of the SM MIMO system by using the signal received through the reception antenna 21 (S310).

The wireless communication channel H constituted by m transmission antennas and n reception antennas is defined as Equation 1.

$$H = [ \begin{matrix}{h}_{11} & {h}_{12} & … & {h}_{1 m} \\ {h}_{21} & {h}_{22} & … & {h}_{2 m} \\ ⋮ & ⋮ & ⋱ & ⋮ \\ {h}_{n 1} & {h}_{n 2} & … & {h}_{n m}\end{matrix} ] \qquad ( Equation 1 )$$

That is, as shown in FIG. 4, a wireless communication channel H of the SM MIMO system constituted by 2 transmission antennas and 2 reception antennas may be defined as Equation 2.

$$H = [ \begin{matrix}{h}_{11} & {h}_{12} \\ {h}_{21} & {h}_{22}\end{matrix} ] = [ \begin{matrix}{h}_{1} & {h}_{2}\end{matrix} ] \qquad ( Equation 2 )$$

Where hᵢ represents an i-th column of H.

The system capacity calculator 220 divides an m×n SM MIMO system into m virtual single input multiple output (SIMO) systems (S320) to calculate a capacity (H(x;y)) of the SM MIMO system and capacities (H(x₁;y₁) and H(x₂;y₂)) of m virtual SIMO systems (S330). At this time, m=n.

When the channel estimated by the channel estimator 210 is H, the capacity of the SM MIMO system is defined as Equation 3.

$$H ( x ; y ) = {log}_{2} [ det ( I + \frac{{E}_{s}}{2 {N}_{0}} H {H}^{H} ) ] \qquad ( Equation 3 )$$

For convenience of description, when Equation 3 is developed by using Equation 2, the capacity of 2×2 SM MIMO system may be expressed as shown in Equation 4.

$$\begin{matrix}H ( x ; y ) = {log}_{2} [ det ( I + \frac{{E}_{s}}{2 {N}_{0}} H {H}^{H} ) ] \\ = {log}_{2} [ \begin{matrix}( 1 + \frac{{E}_{s}}{2 {N}_{0}} {‖ {h}_{1} ‖}^{2} ) ( 1 + \frac{{E}_{s}}{2 {N}_{0}} {‖ {h}_{2} ‖}^{2} ) - \\ {( \frac{{E}_{s}}{2 {N}_{0}} )}^{2} {h}_{1}^{H} {h}_{2} {h}_{2}^{H} {h}_{1}\end{matrix} ] \\ = {log}_{2} [ 1 + \frac{{E}_{s}}{2 {N}_{0}} {‖ {h}_{1} ‖}^{2} ] + \\ {log}_{2} [ 1 + \frac{{E}_{s}}{2 {N}_{0}} {‖ {h}_{2} ‖}^{0} ] + \\ {log}_{2} [ 1 + \frac{- {( \frac{{E}_{s}}{2 {N}_{0}} )}^{2} {( {h}_{1}^{H} {h}_{2} )}^{2}}{( 1 + \frac{{E}_{s}}{2 {N}_{0}} {‖ {h}_{1} ‖}^{2} ) ( 1 + \frac{{E}_{s}}{2 {N}_{0}} {‖ {h}_{2} ‖}^{2} )} ] \\ = H ( {x}_{1} ; {y}_{1} ) + H ( {x}_{2} ; {y}_{2} ) + H ( Loss )\end{matrix} \qquad ( Equation 4 )$$

In Equation 4, H(x₁;y₁) is the same as an SIMO system when it is assumed that a second transmission stream X₂ is accurately known as shown in FIG. 5. H(x₂;y₂) is the same as an SIMO system when it is assumed that a second transmission stream X₁ is accurately known as shown in FIG. 6. That is, the 2×2 SM MIMO system may be divided into two virtual SIMO systems. Further, when the 2×2 SM MIMO system may be divided into two virtual SIMO systems as shown in FIGS. 5 and 6, H(Loss) represents a loss generated due to the correlation between both channels. That is, H(Loss) may be analyzed as an amount of interference which two streams X1 and X2 give with each other and always has a negative value.

The loss calculator 230 calculates a loss (H(x₁;y₁)) generated due to the interference among the plurality of streams as many as the number of transmission antennas on the basis of the capacity (H(x₁;y₁)) of the SM MIMO system and the capacities (H(x₁;y₁) and H(x₂;y₂)) of two virtual SIMO systems (S340).

Specifically, H(Loss) may be expressed as shown in Equation 5 by using Equation 4.

H(Loss)=H(x;y)−H(x₁;y₁)−H(x₂;y₂) (Equation 5)

At this time, when the number of antennas is 3 or more, H(LOSS) of Equation 5 may be expressed as shown in Equation 6.

$$H ( Loss ) = H ( x ; y ) - {\sum }_{n = 1}^{Nt} H ( {x}_{n} ; {y}_{n} ) \qquad ( Equation 6 )$$

Referring to Equation 6, H(Loss) always has the negative value.

The stream capacity approximator 240 calculates the capacity (Cₙ) of each stream by using the loss (H(Loss)) generated due to the interference among the plurality of streams (S350). At this time, the stream capacity approximator 240 uses a channel capacity equation of Shannon.

The channel capacity equation of Shannon is shown in Equation 7.

Cₙ=log₂(1+SINRₙ) (Equation 7)

Wherein Cₙ is a capacity of an n-th stream and SINR, is an SINR of the n-th stream.

By using Equation 7, SINRₙ may be expressed as shown in Equation 8.

SINRₙ=2^{C}^{ₙ}−1 (Equation 8)

In general, a method for calculating Cₙ in an interference channel is not still known and as a result, in the exemplary embodiment of the present invention, an approximating method of Equation 9 using H(Loss) acquired through Equation 6 is used.

Cₙ≈H(xₙ;yₙ)+β·H(Loss) (Equation 9)

Herein, β is a correction parameter for correcting an error generated due to approximation and β may reflect that the capacity of the ML detector or the detector showing the performance of the ML detection mechanisms is smaller than the maximum capacity of the SM MIMO system of Equation 3. The β may be acquired through a simulation in a system model.

Next, the predictor 250 predicts the SINR of each stream by using Equations 8 and 9 (S360). That is, when the capacity (Cₙ) of each stream acquired through Equations 8 and 9 is substituted, the predictor 250 may acquire an SINRₙ of the n-th stream.

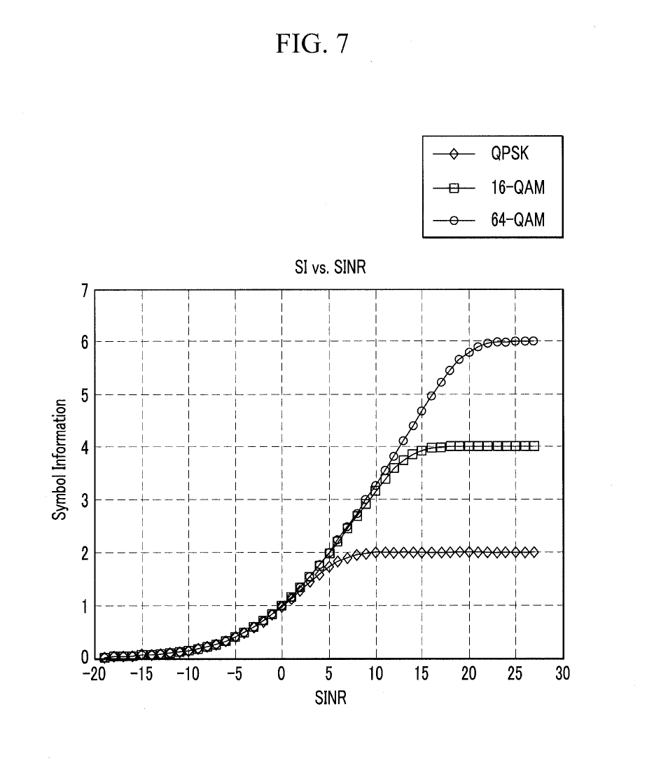

As an example for verifying the efficiency of the acquired SINR, a process of calculating an effective SINR by using the SINRₙ of each sub-carrier in an orthogonal frequency division multiple access (OFDMA) system will be described with reference to FIGS. 7 to 9.

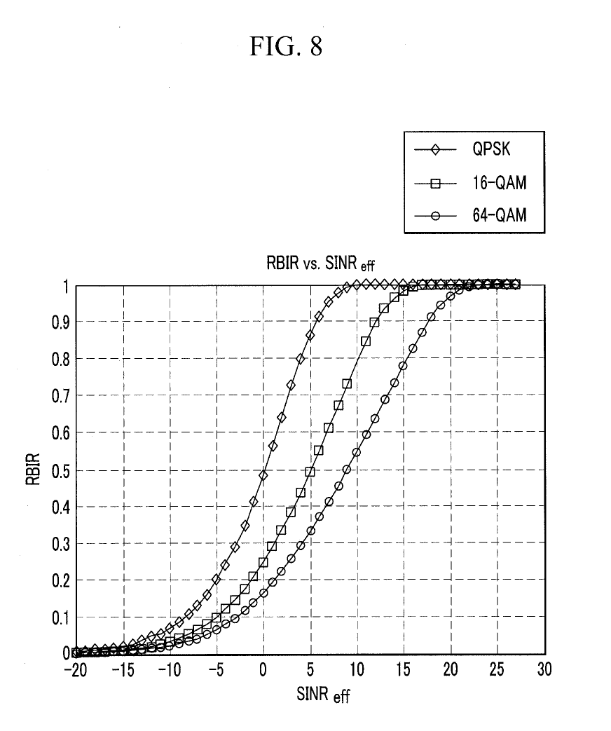

FIG. 7 is a diagram showing a mapping relationship between an SINR and symbol information in an OFDMA system and FIG. 8 is a diagram showing the relationship between a PBIR and an effective SINR in an OFDMA system.

First, when the SINRₙ of each sub-carrier corresponding to one code block (the size of N) is acquired in the OFDMA system, a receiver of the OFDMA system converts the SINRₙ into symbol information (SI) by using the mapping relationship shown in FIG. 7.

The receiver of the OFDMA system calculates received bit information rate (RBIR) by using the symbol information. The RBIR may be calculated as shown in Equation 10.

$$RBIR = \frac{{\sum }_{n = 1}^{N} SI ( {SINR}_{n} , m ( n ) )}{{\sum }_{n = 1}^{N} m ( n )} \qquad ( Equation 10 )$$

Where m(n) is a modulation order of each sub-carrier.

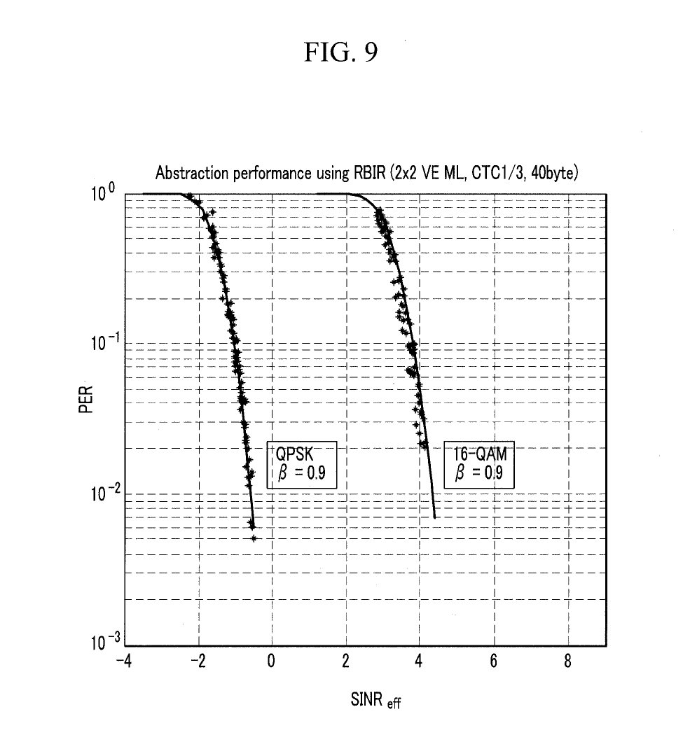

FIG. 9 is a diagram showing a simulation result using an effective SINR. In FIG. 9, a CTC code having code rate of ⅓ is used in IEEE 802.16m and a code block with a source having the size of 40 bytes is considered. Further, QPSK and 16-QAM modulation methods are applied and the correction parameter, β has a value of 0.9. In FIG. 9, a solid line represents the performance of the code block with the source having the size of 40 bytes in AWGN, and “*” represents the effective SINR (SINR_{eff}) acquired by using the SINRₙ of each sub-carrier in the OFDMA system.

Referring to FIG. 9, the effective SINR (SINR_{eff}) acquired by using the SINRₙ of each sub-carrier in the OFDMA system is substantially approximated to the solid line. That is, according to the exemplary embodiment of the present invention, it is possible to more accurately predict the performance of the ML detector or the performance of the detector showing the performance of the ML detection mechanism by using the estimated SINR.

According to an embodiment of the present invention, a receiver (i.e., a terminal) can estimate the performance of a maximum likelihood (ML) detection mechanism with an estimated channel, and the performance of the detector estimated by the receiver is reported to a base station to use various usages for a transmitter (i.e., a base station) to use in performing scheduling or link adaptation.

The above-mentioned exemplary embodiments of the present invention are not embodied only by an apparatus and/or method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for predicting a signal to interference plus noise ratio (SINR) in a receiver of a spatially multiplexed multiple input multiple output (SM MIMO) system, comprising:
estimating a channel by using a plurality of streams received through a plurality of reception antennas;
dividing a capacity of the SM MIMO system into capacities of a plurality of virtual single input multiple output (SIMO) systems by using the estimated channel;
calculating losses generated by the plurality of streams received through the plurality of reception antennas; and
predicting an SINR of each stream by using the losses and the capacities of the plurality of virtual SIMO systems.

2. The method of claim 1, wherein:
the predicting includes,
approximating a capacity of each stream by using the losses and the capacities of the plurality of virtual SIMO systems, and
acquiring the SINR by using the capacity of each stream.

3. The method of claim 2, wherein:
the acquiring includes,
acquiring the SINR by substituting the capacity of each stream in a channel capacity equation of Shannon.

4. The method of claim 1, wherein:
the calculating includes,
calculating the losses by using the capacity of the SM MIMO system and the capacities of the plurality of virtual SIMO.

5. The method of any one of claim 1, wherein:
the number of the plurality of virtual SIMO systems is determined by the number of transmission antennas of the SM MIMO system.

6. The method of any one of claim 1, wherein:
the number of transmission antennas is smaller than or equal to the number of reception antennas in the SM MIMO system.

7. An apparatus for predicting a signal to interference plus noise ratio (SINR) in a spatially multiplexed multiple input multiple output (SM MIMO) antenna system, comprising:
a system capacity calculator dividing the SM MIMO system into a plurality of virtual single input multiple output (SIMO) systems and calculating a capacity of the SM MIMO system and capacities of the plurality of virtual SIMO systems;
a loss calculator calculating losses generated by a plurality of streams received through a plurality of reception antennas by using the capacity of the SM MIMO system and the capacities of the plurality of virtual SIMO systems;
a stream capacity approximator approximating a capacity of each stream by using the losses and the capacities of the plurality of virtual SIMO systems; and
a predictor predicting the SINR of each stream by using the capacity of each stream.

8. The apparatus of claim 7, further comprising:
a channel estimator estimating a channel by using the plurality of streams received through the plurality of reception antennas,
wherein the system capacity calculator calculates the capacity of the SM MIMO system and the capacities of the plurality of virtual SIMO systems by using the estimated channel.

9. The apparatus of claim 7, wherein:
the predictor uses a channel capacity equation of Shannon.

10. The apparatus of claim 7, wherein:
the number of the plurality of virtual SIMO systems is determined by the number of transmission antennas of the SM MIMO system.
